(19) United States
(12) Patent Application Publication
(10) Pub. No.: US 2005/0270372 A1
(43) Pub. Date: Dec. 8, 2005

(54) On-screen display and privacy masking apparatus and method

(76) Inventor: Paul E. Henninger III, Lititz, PA (US)

Correspondence Address: BAKER & DANIELS LLP;111 E. WAYNE STREET, SUITE 800, FORT WAYNE, IN, 46802, US

(21) Appl. No.: 10/859,383

(22) Filed: Jun. 2, 2004

(51) Int. Cl. H04N 9/47

(52) U.S. Cl. 348/143

(57) ABSTRACT

A surveillance camera system that includes a camera, a display screen and a processing device having first and second memory devices. The processing device outputs an informational display that is displayed on the screen and overlays a portion of the images captured by the camera. The processing device also outputs a privacy mask which is displayed on the screen and obscures a selected portion of the images captured by the camera. The position of the privacy mask is adjusted to account for changed in the field of view of the camera. The privacy mask output by the processing device has a first resolution and the informational display output by the processing device has a second resolution, the first resolution being greater than the second resolution.

### BACKGROUND OF THE INVENTION

1. Field of the Invention

The present invention relates to video surveillance camera systems and, more specifically, to on-screen displays and privacy masking for such systems.

2. Description of the Related Art

Video surveillance camera systems are found in many locations and may include either fixed cameras that have a fixed field of view and/or adjustable cameras that can pan, tilt and/or zoom to adjust the field of view of the camera. The video output of such cameras is typically communicated to a central location where it is displayed on one of several display screens. Security personnel may monitor the display screens for suspicious activity. The camera system may also include various functions which require the input of the security personnel. To facilitate the input of data or commands by the use of the camera system, the system may provide for the on-screen display of information either textual or graphic. For example, a menu structure may be displayed on the display screen. When such on-screen display of information occurs, the displayed information will block, or at least obscure, at least a portion of the underlying video image being captured by the camera associated with the screen displaying the information.

When employing a video surveillance camera system, the area within the field of view of a camera in the system may include both the area for which monitoring is intended and private areas. In such circumstances, it is known to provide privacy masking which obscures that portion of the video image which corresponds to the private area. When the camera is a pan, tilt, zoom camera having an adjustable field of view, the portion of the displayed image corresponding to the private area will change as the field of view of the camera changes.

One known method of providing such a privacy mask renders the privacy mask at the same resolution as the individual character maps that are used with the on-screen displays. For example, if the individual character maps have a size of 10×16 pixels, the privacy mask might be rendered in solid colored blocks of 10×16 pixels. Rendering a privacy mask in this manner, however, will typically lead to a relatively imprecise rendering of the privacy mask that does not closely conform to the area for which privacy masking is desired.

Thus, although various systems have addressed the need to provide for the on-screen display of information and/or the use of privacy masks in a surveillance camera system, there remains a need to improve the performance of such systems.

### SUMMARY OF THE INVENTION

The present invention provides a surveillance camera system that provides for the overlay of an informational display and the use of a privacy mask with the video images captured by a camera in the system.

The invention comprises, in one form thereof, a surveillance camera system that includes a camera having an adjustable field of view, a display screen operably coupled with the camera wherein images captured by the camera are displayable on the display screen, and a processing device including a first memory device and a second memory device. The processing device is configured to output an informational display. The processing device is also operably coupled to the display screen wherein informational displays output by the processing device are displayed on the display screen and overlay a portion of the images captured by the camera. The processing device is further configured to output a privacy mask wherein a privacy mask output by the processing device is displayed on the display screen and obscures a selected portion of the images captured by the camera and the position of the privacy mask is adjusted to account for changes in the field of view of the camera. The first memory device stores data associated with the informational display and the second memory device stores data associated with the privacy mask. The privacy mask output by the processing device is merged with the captured images at a first resolution and the informational displays output by the processing device are merged with the captured images at a second resolution, the first resolution being greater, i.e., finer, than the second resolution.

The present invention comprises, in another form thereof, a method of generating a display in a surveillance camera system. The method includes acquiring video images with a camera wherein the camera has a variable field of view, displaying the acquired video images on a display screen, overlaying a portion of the video images displayed on the display screen with an on-screen informational display, and obscuring a selected portion of the video images to provide a privacy mask. The method also includes merging the privacy mask with the video images at a first resolution and merging the informational display with the video images at a second resolution, the first resolution being greater than the second resolution.

The present invention comprises, in another form thereof, a method of generating a display in a surveillance camera system. The method includes acquiring video images with a camera wherein the camera has a variable field of view, displaying the acquired video images on a display screen, overlaying a portion of the video images displayed on the display screen with an on-screen informational display, and obscuring a selected portion of the video images displayed on the display screen to provide a privacy mask. The method also includes storing a first character map having a plurality of characters in a rewritable memory device wherein the step of overlaying a portion of the video images displayed on the display screen with an on-screen informational display includes displaying selected characters from the character map as a part of the on-screen informational display and wherein the first character map stored on the rewritable memory device can be replaced with a second character map storable on the rewritable memory device.

An advantage of the present invention is that it allows the privacy mask to be determined at a resolution that is greater than that used with the informational display.

Another advantage of the invention is that it allows for the upgrading of a character map used with the informational display and facilitates the use of characters having a relatively large size, e.g., Chinese characters.

Still another advantage of the present invention is that it may be utilized in a processing module that is separate from the camera assembly which allows for the camera assembly to output a clean video signal to which a privacy mask and on-screen textual or graphical displays are subsequently applied.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic view of video surveillance system in accordance with the present invention.

FIG. 2 is a schematic view of the processing device of FIG. 1.

FIG. 3 is a schematic view of a portion of the processing device and which may be used with an analog video signal.

FIG. 4 is a view of an individual unit of an informational display.

FIG. 5 is another view of an individual unit of an informational display.

FIG. 6 is a flow chart illustrating the algorithm by which a privacy mask is defined.

FIG. 7 is a flow chart illustrating the algorithm by which a privacy mask is displayed on a display screen.

FIG. 8 is a schematic depiction of a screen display with the camera defining a first field of view and including a privacy mask and an informational display.

FIG. 9 is a schematic depiction of a screen display with the camera defining a second field of view and including the privacy mask of FIG. 8 and a different informational display.

Corresponding reference characters indicate corresponding parts throughout the several views. Although the exemplification set out herein illustrates an embodiment of the invention, the embodiment disclosed below is not intended to be exhaustive or to be construed as limiting the scope of the invention to the precise form disclosed.

### DESCRIPTION OF THE PRESENT INVENTION

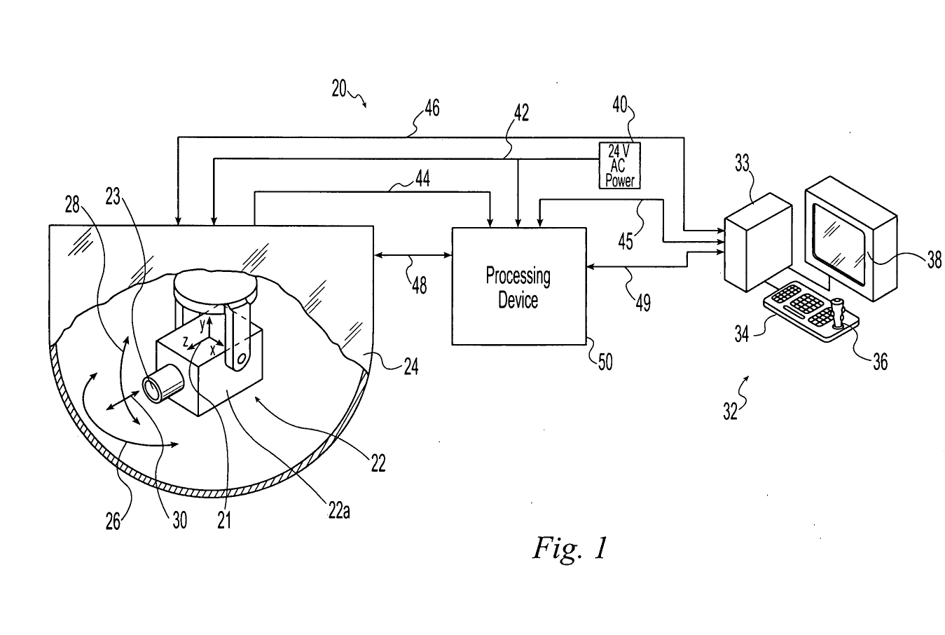

In accordance with the present invention, a video surveillance system 20 is shown in FIG. 1. System 20 includes a camera 22 which is located within a partially spherical enclosure 24. Enclosure 24 is tinted to allow the camera to acquire images of the environment outside of enclosure 24 and simultaneously prevent individuals in the environment being observed by camera 22 from determining the orientation of camera 22. Camera 22 includes motors which provide for the panning, tilting and adjustment of the focal length of camera 22. Panning movement of camera 22 is represented by arrow 26, tilting movement of camera 22 is represented by arrow 28 and the changing of the focal length of the lens 23 of camera 22, i.e., zooming, is represented by arrow 30. As shown with reference to coordinate system 21, panning motion corresponds to movement along the x-axis, tilting motion corresponds to movement along the y-axis and focal length adjustment corresponds to movement along the z-axis. In the illustrated embodiment, camera 22 and enclosure 24 are a Phillips AutoDome® Camera Systems brand camera system, such as the G3 Basic AutoDome® camera and enclosure, which are available from Bosch Security Systems, Inc. formerly Phillips Communication, Security & Imaging, Inc. having a place of business in Lancaster, Pa. A camera suited for use with present invention is described by Sergeant et al. in U.S. Pat. No. 5,627,616 entitled Surveillance Camera System which is hereby incorporated herein by reference.

System 20 also includes a head end unit 32. Head end unit 32 may include a video switcher or a video multiplexer 33. For example, the head end unit may include an Allegiant brand video switcher available from Bosch Security Systems, Inc. formerly Phillips Communication, Security & Imaging, Inc. of Lancaster, Pa. such as a LTC 8500 Series Allegiant Video Switcher which provides inputs for up to 64 cameras and may also be provided with eight independent keyboards and eight monitors. Head end unit 32 includes a keyboard 34 and joystick 36 for operator or user input. Head end unit 32 also includes a display device in the form of a monitor 38 for viewing by the operator. A 24 volt a/c power source 40 is provided to power both camera 22 and a processing device 50 that is operably coupled to both camera 22 and head end unit 32.

Illustrated system 20 is a single camera application, however, the present invention may be used within a larger surveillance system having additional cameras which may be either stationary or moveable cameras or some combination thereof to provide coverage of a larger or more complex surveillance area. One or more VCRs or other form of analog or digital recording device may also be connected to head end unit 32 to provide for the recording of the video images captured by camera 22 and other cameras in the system.

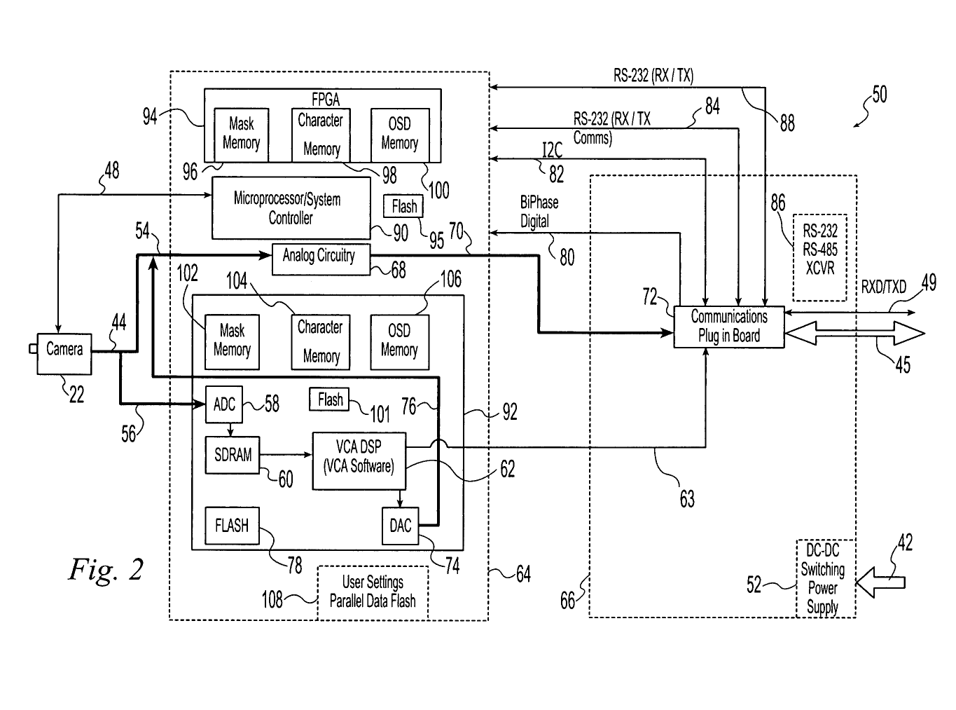

The hardware architecture of processing device 50 is schematically represented in FIG. 2. In the illustrated embodiment, processing device 50 includes a system controller board 64. A power supply/IO section 66 of processing device 50 is illustrated as a separate board in FIG. 2, however, this is done for purposes of clarity and the components of power supply/IO section 66 would be directly mounted to system controller board 64. A power line 42 connects power source 40 to converter 52 in order to provide power to processing device 50. Processing device 50 receives a raw analog video feed from camera 22 via video line 44, and video line 45 is used to communicate video images to head end unit 32. In the illustrated embodiment, video lines 44, 45 are coaxial, 75 ohm, 1 Vp-p and include BNC connectors for engagement with processing device 50. The video images provided by camera 22 can be analog and may conform to either NTSC or PAL standards. Board 72 can be a standard communications board capable of handling biphase signals and including a coaxial message integrated circuit (COMIC) for allowing two-way communication over video links.

Via another analog video line 56, an analog to digital converter 58 receives video images from camera 22 and converts the analog video signal to a digital video signal. After the digital video signal is stored in a buffer in the form of SDRAM 60, the digitized video images are passed to video content analysis digital signal processor (VCA DSP) 62. A video stabilization algorithm is performed in VCA DSP 62. The adjusted display image is sent to digital to analog converter 74 where the video signal is converted to an analog signal. The resulting annotated analog video signal is sent via analog video lines 76, 54, analog circuitry 68 and analog video line 70 to communications plug-in board 72, which then sends the signal to head end unit 32 via video line 45.

Processor 62 may be a TIDM 642 multimedia digital signal processor available from Texas Instruments Incorporated of Dallas, Tex. At start up, the programmable media processor 62 loads a bootloader program. The boot program then copies the VCA application code from a memory device such as flash memory 78 to SDRAM 60 for execution. In the illustrated embodiment, flash memory 78 provides 4 megabytes of memory and SDRAM 60 provides 32 megabytes of memory. Since the application code from flash memory 78 is loaded on SDRAM 60 upon start up, SDRAM 60 is left with approximately 28 megabytes of memory for video frame storage and other software applications.

In the embodiment shown in FIG. 2, components located on system controller board 64 are connected to communications plug-in board 72 via a high speed serial communications bus 63, biphase digital data bus 80, an 12C data bus 82, and RS-232 data buses 84, 88. An RS-232/RS-485 compatible transceiver 86 may also be provided for communication purposes. Coaxial line 45 provides communication between processing device 50 and head end unit 32 via communications plug in board 72. Various additional lines, such as line 49, which can be in the form of an RS-232 debug data bus, may also be used to communicate signals from head end unit 32 to processing device 50. The signals communicated by these lines, e.g., lines 45 and 49, can include signals that can be modified by processing device 50 before being sent to camera 22. Such signals may be sent to camera 22 via line 48 in communication with a microcontroller 90. In the illustrated embodiment, microcontroller 90 is a H8S/2378 controller commercially available from Renesas Technology America, Inc. having a place of business in San Jose, Calif.

Microcontroller 90 operates system controller software and is also in communication with VCA components 92. Although not shown, conductive traces and through-hole vias lined with conductive material are used provide electrical communication between the various components mounted on the printed circuit boards depicted in FIG. 2. Thus, VCA components such as VCA DSP 62 can send signals to camera 22 via microcontroller 90 and line 48. It is also possible for line 46 to be used to communicate signals directly to camera 22 from head end unit 32 without communicating the signals through processing device 50. Various alternative communication links between processing device 50 and camera 22 and head unit 32 could also be employed with the present invention.

System controller board 64 also includes a field programmable gate array (FPGA) 94 including three memory devices, i.e., a mask memory 96, a character memory 98, and an on-screen display (OSD) memory 100. In the illustrated embodiment, FPGA 94 may be a FPGA commercially available from Xilinx, Inc. having a place of business in San Jose, Calif. and sold under the name Spartan 3. In the illustrated embodiment, mask memory 96 is a 4096×16 dual port random access memory module, character memory 98 is a 4096×16 dual port random access memory module and OSD memory 100 is a 1024×16 dual port random access memory module. Similarly, VCA components 92 includes a mask memory 102, a character memory 104, and an on-screen display (OSD) memory 106 which may also be dual port random access memory modules. These components may be used to mask various portions of the image displayed on-screen 38 or to generate textual displays for screen 38. More specifically, this configuration of processing device 50 enables the processor to apply privacy masks and on-screen displays to either an analog video signal or a digital video signal.

If it is desired to apply the privacy masks and on-screen displays to a digital image signal, memories 102, 104 and 106 would be used and the processing necessary to calculate the position of the privacy masks and on-screen displays would take place in processor 62. If the privacy masks and on-screen displays are to be applied to an analog video signal, memories 96, 98, and 100 would be used and the processing necessary calculate the position of the privacy masks and on-screen displays would take place in microprocessor 90. The inclusion of VCA components 92, including memories 102, 104, 106 and processor 62, in processing device 50 facilitates video content analysis, such as for the automated tracking of intruders. Alternative embodiments of processing device 50 which do not provide the same video content analysis capability, however, may be provided without VCA components 92 to thereby reduce costs. In such an embodiment, processing device 50 would still be capable of applying privacy masks and on-screen displays to an analog video signal through the use of microprocessor 90 and field programmable arrray (FPGA) 94 with its memories 96, 98, and 100.

Processing device 50 also includes rewritable flash memory devices 95, 101. Flash memory 95 is used to store data including character maps that are written to memories 98 and 100 upon startup of the system. Similarly flash memory 101 is used to store data including character maps that are written to memories 104 and 106 upon startup of the system. By storing the character map on a rewritable memory device, e.g., either flash memory 95, 101, instead of a read-only memory, the character map may be relatively easily upgraded at a later date if desired by simply overwriting or supplementing the character map stored on the flash memory. System controller board 64 also includes a parallel data flash memory 108 for storage of user settings including user-defined privacy masks wherein data corresponding to the user-defined privacy masks may be written to memories 96 and/or 102 upon startup of the system.

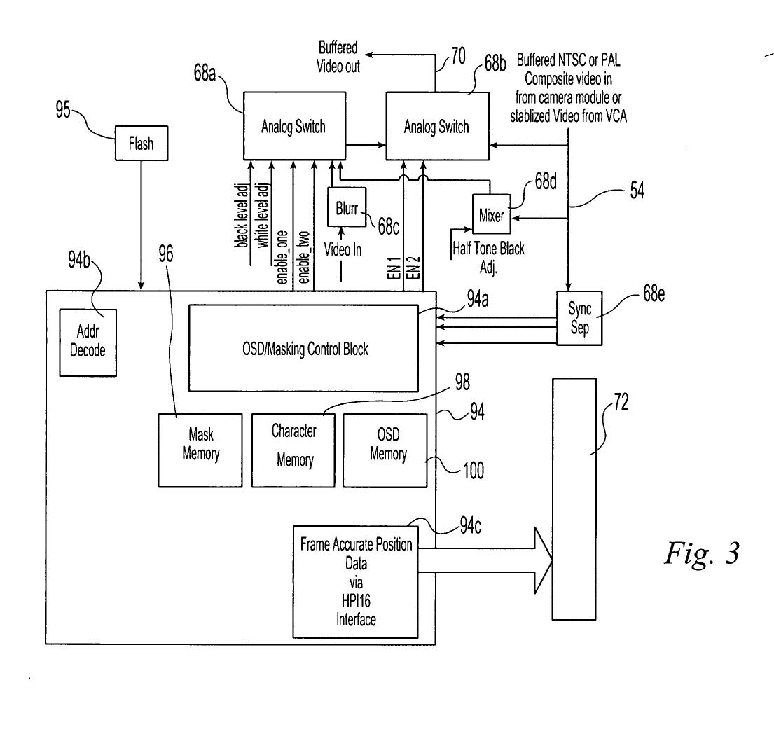

FIG. 3 provides a more detailed schematic illustration of FPGA 94 and analog circuitry 68 than that shown in FIG. 2. As seen in FIG. 3, in addition to mask memory 96, character memory 98 and OSD memory 100, FPGA 94 also includes an OSD/Masking control block 94a, an address decoder 94b, and an optional HPI16 interface 94c for communicating frame accurate position data. The HPI16 interface is used when the privacy mask and informational displays, e.g., individual text characters, are to be merged with a digital video image using VCA components 92.

As also seen in FIG. 3, analog circuitry (shown in a more simplified manner and labeled 68 in FIG. 2) includes a first analog switch 68a, a second analog switch 68b, a filter 68c, an analog multiplexer 68d, and a video sync separator 68e. A “clean” analog video signal, i.e., although the image may be stabilized, the video signal includes substantially all of the image captured by camera 22 without any substantive modification to the content of the image, is conveyed by line 54 to the second analog switch 68b, mixer 68c and sync separator 68e. An analog video signal is conveyed from mixer 68c to first analog switch 68a. Mixer 68c also includes a half tone black adjustment whereby portions of the video signal may be modified with a grey tone. Sync separator 68e extracts timing information from the video signal which is then communicated to FPGA 94. A clean analog video signal, such as from FPGA 94 or line 54, is also received by filter 68c. Passing the analog video signal through filter 68c blurs the image and the blurred image is communicated to analog switch 68a. Analog switch 68a also has input lines which correspond to black and white inputs. Two enable lines provide communication between analog switch 68a and FPGA 94. The two enable lines allow FPGA 94 to control which input signal received by analog switch 68a is output to analog switch 68b. As can also be seen in FIG. 3, second analog switch 68b includes two input lines, one corresponding to a “clean” analog video signal from line 54 and the output of analog switch 68a. Two enable lines provide communication between analog switch 68b and FPGA 94 whereby FPGA 94 controls which signal input into analog switch 68b is output to line 70 and subsequently displayed on display screen 38.

Each individual image, or frame, of the video sequence captured by camera 22 is comprised of pixels arranged in a series of rows and the individual pixels of each image are serially communicated through analog circuitry 68 to display screen 38. When analog switch 68b communicates clean video signals to line 70 from line 54, the pixels generated from such a signal will generate on display screen 38 a clear and accurate depiction of a corresponding portion of the image captured by camera 22. To blur a portion of the image displayed on-screen 38 (and thereby generate a privacy mask), analog switch 68a communicates a blurred image signal, corresponding to the signal received from filter 68c, to analog switch 68b and switch 68b communicates this blurred image to line 70 for the pixels used to generate the selected portion of the image that corresponds to the privacy mask. If a grey tone privacy mask is desired, the input signal from mixer 68d (instead of the blurred image signal from filter 68c) can be communicated through switches 68a and 68b and line 70 to display screen 38 for the selected portion of the image. To generate on-screen displays, e.g., black text on a white background, analog switch 68a communicates the appropriate signal, either black or white, for individual pixels to generate the desired text and background to analog switch 68b which then communicates the signal to display screen 38 through line 70 for the appropriate pixels. Thus, by controlling switches 68a and 68b, FPGA 94 generates privacy masks and informational displays on display screen 38 in a manner that can be used with an analog video signal. In other words, pixels corresponding to privacy masks or informational displays are merged with the image captured by camera 22 by the action of switches 68a and 68b.

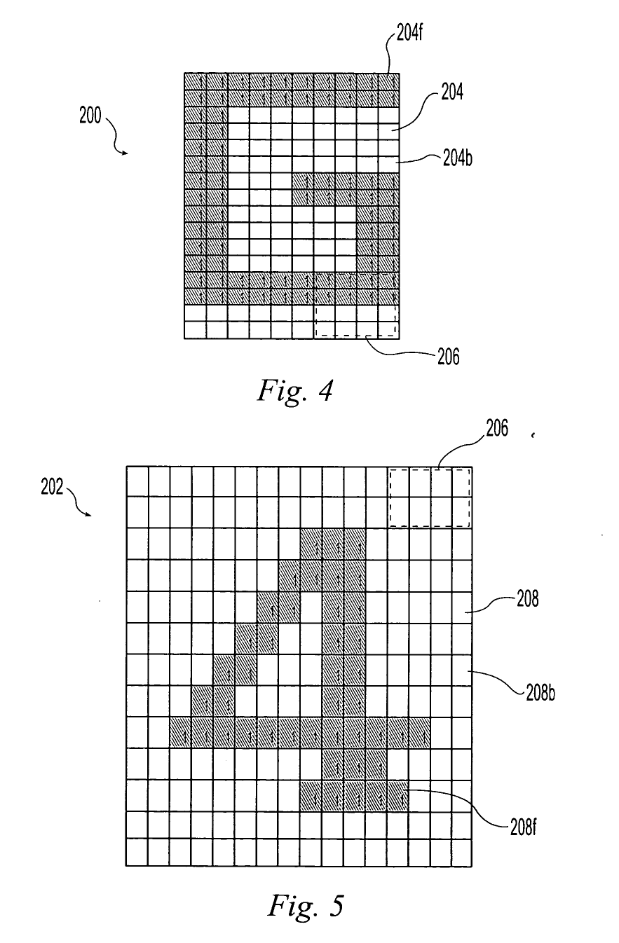

As described above, a character map is stored in memory 98 and may be used in the generation of the informational displays. These individual character maps each correspond to a block of pixels and describe which of the pixels in the block are the background and which of the pixels are the foreground wherein the background and foreground have different display characteristics, e.g., the foreground and background being black and white or some other pair of contrasting colors, to form the desired character. These individual character maps may then be used to control switches 68a, 68b to produce the desired block of pixels on display screen 38. Examples of individual character maps that may be stored in memory 98 are illustrated in FIGS. 4 and 5. In the illustrated examples, a character map 200 for the letter “G” shown in FIG. 4 is 10 pixels wide and 16 rows high, in other words, a 10×16 pixel block. The character map 202 for the number “4” shown in FIG. 5 is 16 pixels wide and 13 rows high wherein each row contains two horizontal lines of pixels, in other words a 16×26 pixel block. In this example, a complete character set is provided for each of these two different sizes so that text may be displayed on display screen 38 in either or both a large, i.e., a 16×26 pixel block character, and small, i.e., a 10×16 pixel block character, size to generate an informational display. While the character map displayed in FIG. 4 has a size of 10×16 pixels, additional background pixels will be rendered along the outer perimeter of the map when displaying the character map to effectively form a character map having a size of 12×18 pixels.

As can be seen in FIGS. 4 and 5, the character maps assign certain pixels within the map a value of “1” to distinguish the foreground from the background and thereby define the character. The pixels designated with a “1” may then be displayed on the screen in a different color than the background pixels (which would be assigned a value of “0”).

In the character map displayed in FIG. 4, each of the individual grid units 204 represents a single pixel with the pixel designated 204f representing a foreground pixel and the pixel designated 204b representing a background pixel. In the illustrated embodiment, the privacy mask is defined on an individual pixel basis and rendered in 4×4 pixel blocks. The area within dashed line 206 represents the area of a single such 4×4 pixel block that might be used in the rendering of a privacy mask. In character map 202 displayed in FIG. 5, each of the individual grid units 208 is one pixel wide and two pixels high. Similar to character map 200, character map 202 assigns certain pixels a value of “1” to distinguish the foreground from the background and thereby define the character. In FIG. 5, the grid unit designated 208f represents two foreground pixels while the grid unit designated 208b represents two background pixels. A dashed line 206 can also be seen in FIG. 5 to illustrate the size of the 4×4 pixel block contained within dashed line 206 relative to the size of character map 202.

It is known to display privacy masks at the same resolution as a character map, in other words, a privacy mask rendered at the same resolution as the character map of FIG. 4 would be rendered in individual pixel blocks of 10×16 pixels, e.g., by applying a character map in which all of the pixels within the map were foreground pixels. As described above, however, in the illustrated embodiment of the present invention, the privacy mask is rendered in 4×4 pixel blocks while the individual characters forming the informational displays are rendered in larger pixel blocks, i.e., 10×16 or 16×26 pixel blocks. In other words, the privacy mask is merged with the video image at a first resolution and the characters are merged with the video image at a second resolution wherein the first resolution at which the privacy mask is merged is greater, i.e., finer, than the second resolution at which the characters are merged.

As mentioned above, the privacy mask is rendered in individual pixel blocks 206 that are 4×4 pixels in size and the implementation of the privacy mask can be described generally as follows. Initially, the user defines the boundaries of the privacy mask. When the field of view of camera 22 changes, new transformed boundaries for the privacy mask that correspond to the new field of view are calculated. The privacy mask area defined by the new boundaries is then rendered, or infilled, using 4×4 pixel blocks. By using relatively small pixel blocks, i.e., 4×4 pixel blocks instead of 10×16 pixel blocks, to completely fill the new transformed boundaries of the privacy mask, the privacy mask will more closely conform to the actual subject matter for which privacy masking is desired as the field of view of the camera changes.

This rendering of the privacy mask in 4×4 pixel blocks does not require that the privacy mask boundaries be defined in any particular manner and the mask may be rendered at this resolution regardless of the precision at which the mask is initially defined. The process of defining and transforming a privacy mask is described in greater detail below.

In the illustrated embodiment, commands may be input by a human operator at head end unit 32 and conveyed to processing device 50 via one of the various lines, e.g., lines 45, 49, providing communication between head end unit 32 and processing device 50 which also convey other serial communications between head end unit 32 and processing device 50. In the illustrated embodiment, processing device 50 is provided with a sheet metal housing and mounted proximate camera 22. Processing device 50 may also be mounted employing alternative methods and at alternative locations. Alternative hardware architecture may also be employed with processing device 50. It is also noted that by providing processing device 50 with a sheet metal housing its mounting on or near a PTZ (pan, tilt, zoom) camera is facilitated and system 20 may thereby provide a stand alone embedded platform which does not require a personal computer-based system.

The provision of a stand-alone platform as exemplified by processing device 50 also allows the present invention to be utilized with a video camera that outputs unaltered video images, i.e., a “clean” video signal that has not been modified. After being output from the camera assembly, i.e., those components of the system within camera housing 22a, the “clean” video may then have a privacy mask and on-screen displays applied to it by the stand-alone platform. Typically, the use of privacy masking precludes the simultaneous use of automated tracking because the application of the privacy mask to the video image, oftentimes done by a processing device located within the camera housing, obscures a portion of the video image and thereby limits the effectiveness of the video content analysis necessary to perform automated tracking. The use of a stand-alone platform to apply privacy masking and on-screen informational displays to clean video images output by a camera allows for the use of automated tracking, or other applications requiring video content analysis, without requiring the camera assembly itself to include the hardware necessary to perform all of these features. If it was desirable, however, processing device 50 could also be mounted within housing 22a of the camera assembly.

Processing device 50 can perform several functions in addition to the provision of privacy masking and on-screen displays. One such function may be an automated tracking function. For example, processing device 50 may identify moving target objects in the field of view (FOV) of the camera and then generate control signals which adjust the pan, tilt and zoom settings of the camera to track the target object and maintain the target object within the FOV of the camera. An example of an automated tracking system that may be employed by system 20 is described by Sablak et al. in U.S. patent application Ser. No. 10/306,509 filed on Nov. 27, 2002 entitled “VIDEO TRACKING SYSTEM AND METHOD” the disclosure of which is hereby incorporated herein by reference.

As mentioned above, processing device 50 also runs software which enables a user to identify private areas, such as the window of a nearby residence for masking. The privacy mask is then used to obscure the underlying subject matter depicted in the image. For cameras having an adjustable field of view, the masked area must be transformed as the field of view of the camera is changed if the mask is to continue to provide privacy for the same subject matter, e.g., a window of a nearby residence, as the field of view of the camera is changed. Although such privacy masks typically involve the obscuration of the displayed image within the area of the mask, it may alternatively be desirable to provide a virtual privacy mask. For example, a window or other area may include a significant amount of motion that it is not desirable to track but which could activate an automated tracking program. In such a situation, it may be desirable to define a mask for such an area and continue to display the masked area at the same resolution as the rest of the image on display screen 38 but not utilize this area of the image for automated tracking purposes. In other words, for purposes of the automated tracking program the image is “obscured” within the masked area (by reducing the information provided or available for analysis for the masked area) even though the resolution of the image displayed in this area is not reduced. The present invention may also be used with such virtual privacy masks.

Although a specific hardware configuration is discussed above, various modifications may be made to this configuration in carrying out the present invention. In such alternative configurations it is desirable that the update rate of masking is sufficient to prevent the unmasking of the defined mask area during movement of the camera. The method of identifying a masked area and transforming the masked area as the field of view of the camera is changed will now be described.

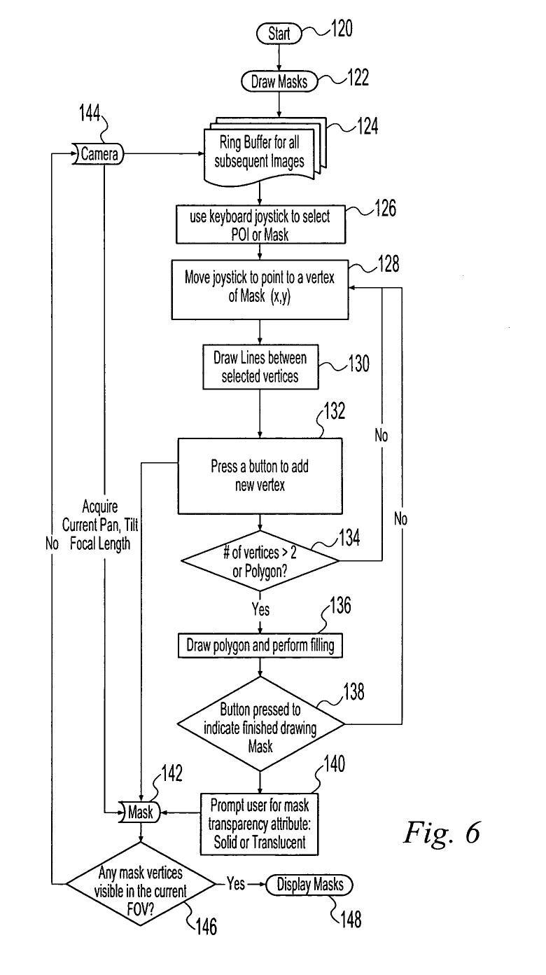

FIGS. 5 and 6 present flowcharts that illustrate the method by which the software running on processing device 50 provides transformable privacy masks. FIG. 5 illustrates the algorithm by which a privacy mask is created by a user of the system. First, the user initiates the draw mask function by selecting this function from an interactive menu or by another suitable means as indicated at 120, 122. As the draw mask function is initiated, the most recently acquired images are continuously stored by the processing device as indicated at 124. The user first directs the software that a privacy mask will be drawn instead of selecting a point of interest (POI) as indicated at 126. A POI may be selected when employing a video tracking program to track the POI. The user then manipulates joystick 36 to select a mask vertex (x, y) as indicated at 128. A mouse or other suitable means may also be used to select a mask vertex. If more than one mask vertex has been selected, lines connecting the mask vertices are then drawn on the screen as indicated at 130. The user then confirms the selection of the new mask vertex by pushing a particular button or key on joystick 36 or keyboard 34 as indicated at 132. The addition of the new vertex to the mask is indicated by the line leading from box 132 to box 142. The program then determines whether the number of vertices selected for the mask is greater than 2 and whether or not the selected vertices define a polygon as indicated at 134. If the answer to either of these questions is No the program returns to box 128 for the selection of a new mask vertex. If at least three vertices have been chosen and the selected vertices define a polygon, the program draws and fills the mask defined by the vertices as indicated at 136. The user is then asked if the mask is complete or another vertex should be added. If the user indicates that another vertex is to be added to the mask, the program returns to box 128 and the process described above is repeated. If the user has finished adding vertices to the mask and indicates that the mask is complete, the program proceeds to box 140 where the user is asked to select the type of obscuring infill to be used with the mask.

In the illustrated embodiment, the user may select either a solid infill or a translucent infill. A solid mask infill may take the form of a solid color infill, such as a homogenous gray or white infill, that obscures the video image within the mask by completely blocking that portion of the video image which corresponds to the privacy mask. A translucent infill may be formed by reducing the resolution of the video image contained within the privacy mask area to thereby obscure the video image within the privacy mask without blocking the entirety of the video image within the mask. For example, for a digital video signal, the area within the privacy mask may be broken down into blocks containing a number of individual pixels. The values of the individual pixels comprising each block are then averaged and that average value is used to color the entire block. For an analog video signal, the signal corresponding to the area within the mask may be filtered to provide a reduced resolution. These methods of reducing the resolution of a selected portion of a video image are well known to those having ordinary skill in the art.

These methods of obscuring the image may be desirable in some situations where it is preferable to reduce the resolution of the video image within the privacy mask without entirely blocking that portion of the image. For example, if there is a window for which privacy mask is desired and there is also a walkway in front of that window for which surveillance is desired, by using a translucent privacy mask, the details of the image corresponding to the window may be sufficiently obscured by the reduction in resolution to provide the desired privacy while still allowing security personnel to follow the general path of movement of a target object or individual that moves or walks in front of the window.

After selecting the type of infill for the mask, the program records this data together with the mask vertices as indicated at box 142. When initially recording the mask vertices, the pan, tilt and zoom settings of the camera are also recorded with the vertex coordinates as indicated by the line extending from camera box 144 to mask box 142. After the mask has been defined, the program determines whether any of the mask vertices are in the current field of view of the camera as indicated at 146. If no mask vertices are in the current field of view, the camera continues to forward acquired images to the processing device 50 and the images are displayed on display screen 38 without a privacy mask. If there are privacy mask vertices contained within the current field of view of the camera, the program proceeds to display the mask on display screen 38 as indicated by box 148.

FIG. 6 provides a flowchart indicating the method by which privacy masks are displayed on display screen 38 during normal operation of the surveillance camera system 20. The program first determines whether there are any privacy masks that are visible in the current field of view of the camera as indicated at 150. This may be done by using the current pan, tilt and zoom settings of the camera to determine the scope of the current field of view and comparing current field of view with the vertices of the privacy masks that have been defined by the user.

If there is a mask present in the current field of view, the program proceeds to box 152 wherein it obtains the mask data and the current pan and tilt position of the camera. The mask data includes the pan and tilt settings of the camera corresponding to the original mask vertices. The Euler angles and a Rotation matrix are then computed as described below. (As is well known to those having ordinary skill in the art, Euler's rotation theorem posits that any rotation can be described with three angles.) The focal length, or zoom, setting of the camera is then used in the computation of the camera calibration matrix Q₂ as indicated at 154. Homography matrix M is then computed as indicated at 156.

The calculation of the Rotational and homography matrices is used to transform the privacy mask to align it with the current image and may require the translation, scaling and rotation of the mask. Transformation of the mask for an image acquired at a different focal length than the focal length at which the mask was defined requires scaling and rotation of the mask as well as translation of the mask to properly position the mask in the current image. Masks produced by such geometric operations are approximations of the original. The mapping of the original, or reference, mask onto the current image is defined by:
p′=sQRQ⁻¹p=Mp (1)
where p and p′ denote the homographic image coordinates of the same world point in the first and second images, s denotes the scale image (which corresponds to the focal length of the camera), Q is the internal camera calibration matrix, and R is the rotation matrix between the two camera locations.

Alternatively, the relationship between the mask projection coordinates p and p′, i.e., pixel locations (x,y) and (x′, y′), of a stationary world point in two consecutive images may be written as:

$$\begin{matrix}{x}^{′} = \frac{{m}_{11} x + {m}_{12} y + {m}_{13}}{{m}_{31} x + {m}_{32} y + {m}_{33}} & ( 2 ) \\ {y}^{′} = \frac{{m}_{21} x + {m}_{22} y + {m}_{23}}{{m}_{31} x + {m}_{32} y + {m}_{33}} & ( 3 )\end{matrix}$$

Where └mᵢⱼ┘_{3×3} is the homography matrix M that maps (aligns) the first set of coordinates to the second set of coordinates.

The main task in such image/coordinate alignment is to determine the matrix M. From equation (1), it is clear that given s, Q and R it is theoretically straightforward to determine matrix M. In practice, however, the exact values of s, Q, and R are often not known. Equation (1) also assumes that the camera center and the center of rotation are identical, which is typically only approximately true, however, this assumption may be sufficiently accurate for purposes of providing privacy masking. In the illustrated embodiment, camera 22 provides data, i.e., pan and tilt values for determining R and zoom values for determining s, on an image synchronized basis and with each image it communicates to processing device 50.

With this image specific data, the translation, rotation, and scaling of the privacy mask to properly align it for use with a second image can then be performed using the homographic method outlined above. In this method, a translation is a pixel motion in the x or y direction by some number of pixels. Positive translations are in the direction of increasing row or column index: negative ones are the opposite. A translation in the positive direction adds rows or columns to the top or left to the image until the required increase has been achieved. Image rotation is performed relative to an origin, defined to be at the center of the motion and specified as an angle. Scaling an image means making it bigger or smaller by a specified factor. The following approximations may be used to represent such translation, rotation and scaling:
x′=s(x cos α−y sin α)+tₓ
y′=s(y sin α+x cos α)+t_{y} (4)
wherein
s is the scaling (zooming) factor.
α is the angle of rotation about the origin;
tₓ is the translation in the x direction; and
t_{y} is the translation in the y direction.
   By introducing new independent variables a₁=s cos α and a₂=s sin α, equation (4) becomes:
   x′=a₁x−a₂y+tₓ
   y′=a₂x+a₁y+t_{y} (5)
   After determining a₁, a₂, tₓ and t_{y}, the coordinates of the reference mask vertices can be transformed for use with the current image.

The value of Q₁⁻¹ corresponding to the mask being transformed is obtained from a storage device as indicated by the line extending from box 174 to box 156. E.g., this mask data may be stored in mask memory. As described above, when the mask is to be applied to a digital video image, the data will be stored in mask memory 102 and when the mask is to be applied to an analog video signal the data will be stored in mask memory 94. After computation of the homography matrix M, the vertices of the current mask visible in the field of view are identified, as indicated at 158, and then the homography matrix is used to determine the transformed image coordinates of the mask vertices as indicated at 160. The new image coordinates are then mapped onto a 180×360 grid as indicated at 162 and stored in the appropriate mask memory 96 or 102.

After mapping the mask vertex, the program determines if there are any remaining mask vertices that require transformation as indicated at 164. If there are additional mask vertices, the program returns to box 160 where the homography matrix M is used to determine the transformed image coordinates of the additional mask vertex. This process is repeated until transformed image coordinates have been computed for all of the mask vertices. The process then proceeds to box 166 and the polygon defined by the transformed image coordinates is infilled.

The program then determines if there are any additional privacy masks contained in the current field of view as indicated at 168. If there are additional masks, the program returns to box 150 where the additional mask is identified and the process described above is repeated for this additional mask. Once all of the masks have been identified, transformed and infilled, the program proceeds to box 170 where the mask data stored in mask memory, 96 or 102, is retrieved using DMA (direct memory access) techniques for application to the video image signal. The displaying of the privacy masks for the current field of view is then complete as exemplified by box 176.

So long as the field of view of the camera is not changed, the image coordinates of the privacy masks remain constant. If the mask infill is a solid infill, the solid infill remains unchanged until the field of view of the camera changes. If the mask infill is a translucent infill, the relatively large pixel blocks infilling the mask will be updated with each new image acquired by the camera but the location of the pixel blocks forming the privacy mask will remain unchanged until the field of view of the camera is changed. Once the field of view of the camera is changed, by altering one or more of the pan angle, tilt angle or zoom setting (i.e., focal length) of the camera, the display mask algorithm illustrated in FIG. 6 is repeated to determine if any privacy masks are contained in the new field of view and to transform the image coordinates of any masks contained within the field of view so that the masks can be displayed on display screen 38. A method of generating privacy masks that can be used with the present invention is described by Sablak in a U.S. patent application filed on the same date as the present application entitled TRANSFORMABLE PRIVACY MASK FOR VIDEO CAMERA IMAGES assigned to the assignee of the present application and which is hereby incorporated herein by reference. Alternative methods of providing a privacy mask for the video images may also be used with the present invention. The storage capacity of privacy mask memories 96 and 102 allow the privacy mask to be defined and stored and thus subsequently displayed with a relatively high resolution. For example, the privacy mask may be broken down into individual blocks of pixels which each define a vertex of the privacy map and are then transformed and mapped onto the current image in the manner described above as the field of view of the camera changes to define new boundaries for the privacy mask constructed from the sum of the individual blocks used to define the mask. For example, when displaying the privacy mask with a 720×480 pixel NTSC image or a 720×572 PAL image, the originally defined privacy mask may be broken down into small pixel blocks which are then each individually transformed and mapped to the current image, the outer boundary of the transformed blocks is then used to define the new boundaries of the privacy mask for infilling purposes. In alternative embodiments, the originally defined privacy mask could be broken down into other units such as blocks that consist of individual pixels that are then transformed and mapped onto the current image when the field of view changes to thereby define the new boundaries of the privacy mask.

In addition to privacy masks, processing device 50 also outputs informational displays that are then displayed on-screen 38 overlaying a portion of the video image. Unlike privacy masks, the location of the informational displays on-screen 38 will typically not be adjusted when the field of view of the camera is changed. Such informational displays may consist of textual information, such as providing a menu of options when setting up a privacy mask or to provide a viewer with information concerning the status of the surveillance system. Such textual displays may include characters from various languages. For example, it may be desirable for the system to support the use of both English and Chinese characters, among others. For example, a set of English character maps and/or Chinese character maps may be stored in character memory 98, for application to an analog video signal, or in character memory 104, for application to a digital video signal. The OSD memories, 100, 106, for use with character memories 98, 104 respectively, are used to hold addresses of the stored characters for later recall and display. Addresses for English characters are conventionally stored using 8 bits of storage per character, however, addresses for individual Chinese characters may require additional storage capacity, e.g., 16 bits per character address. It may also be desirable to use pictographic icons or other forms of graphic communication which are not necessarily language specific for informational displays. Such pictographic icons and other graphical display information, such as backgrounds for the characters, menu structures and other data associated with the display of information on-screen 38 may also be stored in character memories 98, 104, with addresses of such items stored in OSD memories 100, 106.

When employing memories 96, 98 and 100 for use with an analog video signal, the privacy mask, character and OSD data is stored in a rewritable flash memory module 95 in processor 90 and written to RAM memory modules 96, 98 and 100 upon start-up of the system. Similarly, when employing memories 102, 104 and 106 for use with a digital video signal, data is written to these memories from a rewritable flash memory module 101 upon start-up of the system. After start-up, the individual characters and other OSD data may then be utilized by the various programs, e.g., privacy masking and object tracking programs, to display information to the user or to communicate with the user during user interactions with the system.

Utilizing rewritable memory storage for the character set makes it possible to load the processing device 50 with the appropriate character set after manufacture and when it is determined which character set is required. Moreover, it also permits the overwriting of the original character set and thus the later upgrading or changing of the character set.

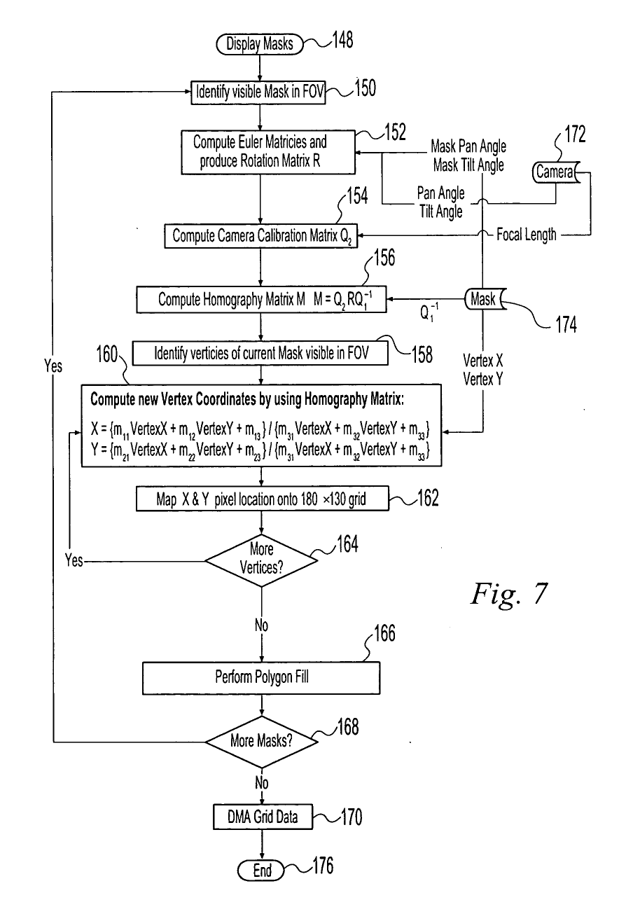

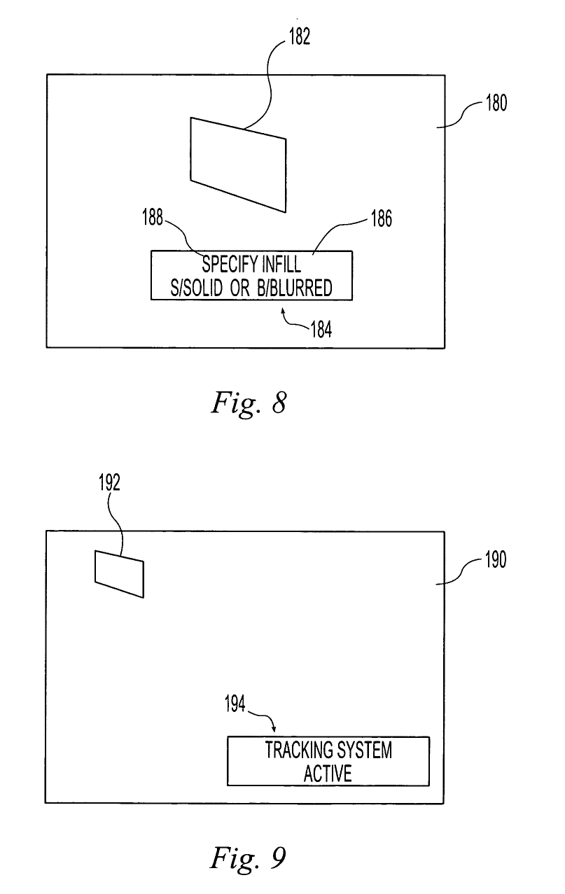

FIGS. 7 and 8 provide examples of what may be displayed on-screen 38 in accordance with the present invention. FIG. 7 schematically depicts a video image 180 that is displayed on-screen 38 when camera 22 defines a first field of view. A privacy mask 182 is also depicted. An informational display 184 having a background 186 on which textual characters 188 are displayed is also depicted in FIG. 5. In the example of FIG. 5, informational display 184 asks the viewer to input the type of infill (either solid or blurred) that should be used with the displayed privacy mask 182. (In alternative embodiments, the characters 188 could be displayed directly over the video image acquired by camera 22 instead of utilizing a solid background 186.)

FIG. 8 schematically depicts a video image 190 that is displayed on-screen 38 after camera 22 has been adjusted to define a second field of view. The privacy mask of FIG. 5 has been transformed to account for the change in the field of view between images 180 and 190 and takes the shape 192 in image 190. FIG. 6 also depicts an informational display 194 which, in the example of FIG. 8, informs the viewer that the tracking system is active.

While this invention has been described as having an exemplary design, the present invention may be further modified within the spirit and scope of this disclosure. This application is therefore intended to cover any variations, uses, or adaptations of the invention using its general principles.

1. A surveillance camera system, said system comprising:
a camera having an adjustable field of view;
a display screen operably coupled with said camera wherein images captured by said camera are displayable on said display screen;
a processing device including a first memory device and a second memory device, said processing device configured to output an informational display, said processing device operably coupled to said display screen wherein informational displays output by said processing device are displayed on said display screen and overlay a portion of said images captured by said camera; said processing device further configured to output a privacy mask wherein a privacy mask output by said processing device is displayed on said display screen and obscures a selected portion of said images captured by said camera, the position of said privacy mask being adjusted to account for changes in the field of view of said camera;
wherein said first memory device stores data associated with said informational display and said second memory device stores data associated with said privacy mask; and
wherein said privacy mask output by said processing device is merged with said captured images at a first resolution and said informational displays output by said processing device are merged with said captured images at a second resolution, said first resolution being greater than said second resolution.

2. The camera system of claim 1 wherein said first and second memory devices are dual port random access memory modules.

3. The camera system of claim 1 wherein said processing device includes a field programmable array, said field programmable array storing a character map, said character map including a plurality of characters, and wherein said privacy mask output by said processing device and said informational displays output by said processing device are applied to an analog video signal.

4. The camera system of claim 3 wherein said field programmable array includes a random access memory module and said processing device further comprises a rewritable flash memory, said character map being stored in said flash memory, and wherein said character map is written to said random access memory module from said flash memory.

5. The camera system of claim 1 wherein said second memory device stores data corresponding to a user defined privacy mask.

6. The camera system of claim 1 wherein said privacy mask is merged with said captured images in individual units having a size of no greater than 4×4 pixels.

7. The camera system of claim 1 wherein said informational displays are merged with said captured images in individual units having a size at least as great as 10×16 pixels.

8. The camera system of claim 7 wherein said privacy mask is merged with said captured images in individual units having a size of no greater than 4×4 pixels.

9. The camera system of claim 1 wherein said privacy mask output by said processing device and said informational displays output by said processing device are both applied to an analog video signal.

10. The camera system of claim 1 wherein said processing device and said camera are disposed within separate housings and wherein said images captured by said camera are communicated substantially unaltered from said camera to said processing device.

11. A method of generating a display in a surveillance camera system, said method comprising:
acquiring video images with a camera wherein the camera has a variable field of view;
displaying the acquired video images on a display screen;
overlaying a portion of the video images displayed on the display screen with an on-screen informational display;
obscuring a selected portion of the video images to provide a privacy mask; and
wherein the privacy mask is merged with the video images at a first resolution and the on-screen informational display is merged with the video images at a second resolution, the first resolution being greater than the second resolution.

12. The method of claim 11 wherein the privacy mask is merged with the video images in individual units having a size of no greater than 4×4 pixels.

13. The method of claim 11 wherein the on-screen informational display is merged with the video images in individual units having a size at least as great as 10×16 pixels.

14. The method of claim 11 wherein the video images having a portion overlayed by an on-screen informational display and having a selected portion obscured to provide a privacy mask are communicated using an analog signal.

15. The method of claim 111 wherein the camera includes a housing and the video images acquired by the camera are communicated substantially unaltered from the camera to a device external to the camera housing, the steps of overlaying a portion of the video images displayed on the display with an on-screen informational display and obscuring a selected portion of the video images displayed on the display screen to provide a privacy mask occurring external to the camera housing.

16. A method of generating a display in a surveillance camera system, said method comprising:
acquiring video images with a camera wherein the camera has a variable field of view;
displaying the acquired video images on a display screen;
overlaying a portion of the video images displayed on the display screen with an on-screen informational display;
obscuring a selected portion of the video images displayed on the display screen to provide a privacy mask; and
storing a first character map having a plurality of characters in a rewritable memory device wherein the step of overlaying a portion of the video images displayed on the display screen with an on-screen informational display includes displaying selected characters from the character map as a part of the on-screen informational display and wherein the first character map stored on the rewritable memory device can be replaced with a second character map storable on the rewritable memory device.

17. The method of claim 16 wherein the individual characters comprising the character map each have an address and the addresses of the individual characters are stored in a dual port random access memory module operably linked to a field programmable array.

18. The method of claim 17 wherein a second rewritable memory device is provided and stores data corresponding to a user defined privacy mask.

19. The method of claim 16 wherein said step of obscuring a selected portion of the video images displayed on the display screen to provide a privacy mask comprises merging the privacy mask with the video images in individual units having a size of no greater than 4×4 pixels.

20. The method of claim 16 wherein said step of overlaying a portion of the video images displayed on the display screen with an on-screen informational display comprises merging the on-screen informational display with the video images in individual units having a size at least as great as 10×16 pixels.

21. The method of claim 20 wherein said step of obscuring a selected portion of the video images displayed on the display screen to provide a privacy mask comprises merging the privacy mask with the video images in individual units having a size of no greater than 4×4 pixels.
